(19) United States
(12) Patent Application Publication
(10) Pub. No.: US 2006/0185398 A1
(43) Pub. Date: Aug. 24, 2006

(54) Method for fabricating a multimode optical fiber preform having longitudinal uniformity

(75) Inventors: Jin-Haing Kim, Seoul (KR); Se Ho Park, Gumi-si (KR); Mun-Hyun Do, Chilgok-gun (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/348,390

(22) Filed: Feb. 6, 2006

(30) Foreign Application Priority Data
Feb. 21, 2005 (KR) 2005-14247

(51) Int. Cl. C03B 37/07; C03B 37/018

(52) U.S. Cl. 65/377; 65/417

(57) ABSTRACT

A method for fabricating a multimode optical fiber preform having a longitudinal uniformity is provided. The method of fabricating includes performing a plurality of radial deposition passes using a thermal source while inserting raw materials into a glass tube. A reference chemical core shape index is set to determine a refractive index profile of a preform section. A core shape index distribution of each longitudinal deposition pass varying in a longitudinal direction of the glass tube is set such that an error of a reference chemical core shape index distribution in the longitudinal direction of the preform defined by the reference chemical core shape index is compensated for and such that a uniform chemical core shape index is obtained in the longitudinal direction. Deposition is performed while an amount of raw materials corresponding to a preset chemical core shape index is inserted in each longitudinal deposition pass of each radial deposition pass.

### CLAIM OF PRIORITY

This application claims priority under 35 U.S.C. § 119 to an application entitled “Method for Fabricating a Multimode Optical Fiber Preform,” filed in the Korean Intellectual Property Office on Feb. 21, 2005 and assigned Serial No. 2005-14247, the contents of which are incorporated herein by reference.

### BACKGROUND OF THE INVENTION

1. Field of the Invention

The present invention generally relates to a method for fabricating an optical fiber preform, and more particularly to a method of fabricating a multimode optical fiber preform whose refractive index varies in a radial direction.

2. Description of the Related Art

Optical fibers are classified as single mode optical fiber for transmitting an optical signal of a single wavelength and multimode optical fiber for transmitting optical signals of multiple wavelengths. Single-mode fiber provides for long transmission distances, suitable for long-distance telephony and multichannel television broadcast systems. Multimode optical fiber, on the other hand, provides for short transmission distances, and is suited for use in LAN systems or access networks and provides high bandwidth at high speeds over medium distances.

An optical fiber preform used to fabricate optical fiber and from which an optical fiber is drawn has a refractive index profile similar to that of the optical fiber. In the conventional manufacturing of an optical fiber preform, the reflective index profile is affected by the core shape index or alpha profile. As illustrated in FIG. 1, the center portion of the alpha profile becomes wider as the core shape index increases from 1.9 to 2.1. Moreover, in the conventional manufacture of optical fiber the uniformity of the bandwidth in the longitudinal direction of the multimode optical fiber is referred to as the gamma. As illustrated in FIG. 2, an optimal core shape index according to a transmission wavelength whereas a core shape is 2.04 when the transmission wavelength is 850 nm and the optimal core shape index is 1.94 when the transmission wavelength is 1,300 nm. Therefore, the core shape index significantly affects the bandwidth and the bandwidth of the multimode optical fiber varies with the length when the core shape index varies in the longitudinal direction.

To obtain the uniform core shape index in the longitudinal direction, raw materials (e.g., GeCl₄ and SiCl₄), reaction oxygen, helium gas, a deposition temperature, and so on must be very precisely controlled when the multimode optical fiber is fabricated. SiCl₄ is the raw material for forming a glass material (referred to as the glass-forming material) and GeCl₄ is the raw material for controlling a refractive index (referred to as the refractive index control material).

FIG. 3 schematically illustrates the conventional method of fabricating a multimode optical fiber preform. The fabrication method performs a plurality of radial deposition passes while inserting raw materials into a glass tube to implement a refractive index profile. In this case, each radial deposition pass indicates the step of forming one deposition layer throughout the total length of the glass tube. The total multimode optical fiber preform is configured by a plurality of layers that are stacked on the glass tube and its inner wall and have different refractive indices. In FIG. 3, the first axis represents a normalized radial deposition pass. The second axis perpendicular to the first axis represents a maximum ratio of the refractive index control material to the glass-forming material, i.e., Max (GeCl₄/SiCl₄). The third axis corresponding to a movement direction of a thermal source 110 is perpendicular to the first and second axes and represents a normalized preform length. The fabrication method includes processes (a) and (b). The normalization indicates, for example, that the first radial deposition pass is set to 0.1 when the total number of radial deposition passes is 10.

The process (a) sets a chemical core shape index for determining a refractive index profile of a preform section (where the reference normalized chemical alpha (NCA)=1). The chemical core shape index is the core shape index in a fabrication process. NCA is obtained by normalizing the set chemical core shape index. When the chemical core shape index is set, Max (GeCl₄/SiCl₄) is determined in each radial deposition pass. Values of the NCA and SiCl₄ are set to constants in the total deposition process. The ratio of GeCl₄ and SiCl₄ inserted in each radial deposition pass directly influences implementation of a preset alpha profile. GeCl₄/SiCl₄ is a function of the normalized radial deposition pass, NCA, and Max (GeCl₄/SiCl₄).

Equation 1, below expresses a flow equation to determine the insertion ratio GeCl₄/SiCl₄ in the process described above.

$$\frac{{GeCl}_{{4}_{@ p}}}{{SiCl}_{{4}_{@ p}}} = Max ( {GeCl}_{4} / {SiCl}_{4} ) [ 1 - {( 1 - NP )}^{NCA} ] \qquad Equation ( 1 )$$

In Equation (1), the refractive index of the multimode fiber is linearly proportional to GeCl₄/SiCl₄, @p denotes each radial process pass, and NP denotes a normalized radial process pass.

The process (b) performs deposition while varying an insertion amount of GeCl₄ throughout the total length of the preform in each radial process pass.

A multimode optical fiber obtained by the conventional method for fabricating a multimode optical fiber preform as described above has a problem in that a bandwidth in the longitudinal direction is frequently irregular. It is difficult for stable optical characteristics to be ensured because the bandwidth varies with a length of the multimode optical fiber due to the irregular bandwidth curve in the longitudinal direction.

Accordingly, a need exists for a method for fabricating a multimode optical fiber preform that can obtain a uniform bandwidth curve in the longitudinal direction.

### SUMMARY OF THE INVENTION

One aspect of the present invention is to provide a method for fabricating a multimode optical fiber preform that can obtain a uniform bandwidth curve in a longitudinal direction.

In accordance with one aspect of the present invention, there is provided a method for fabricating a multimode optical fiber preform by performing a plurality of radial deposition passes using a thermal source while inserting raw materials into a glass tube, comprising the steps of: (a) setting a reference chemical core shape index for determining a refractive index profile of a preform section; (b) setting a core shape index distribution of each longitudinal deposition pass varying in a longitudinal direction of the glass tube such that an error of a reference chemical core shape index distribution in the longitudinal direction of the preform defined by the reference chemical core shape index is compensated for and such that a uniform chemical core shape index is obtained in the longitudinal direction; and (c) performing deposition while inserting an amount of raw materials corresponding to a preset chemical core shape index in each longitudinal deposition pass of each radial deposition pass.

Preferably, Max (B/A) may be determined which represents a maximum ratio of a refractive index control material B to a glass-forming material A in each radial deposition pass when the reference chemical core shape index is set, and an amount of the refractive index control material B inserted in each longitudinal deposition pass of the step (c) may be given by:
B_{@p}=A_{@p}×Max(B/A)[1−(1−NP)^{NCA*}], Equation (2)

In Equation (2), @p denotes each radial process pass, NP denotes a normalized radial process pass, and NCA* denotes a normalized chemical core shape index in each longitudinal deposition pass.

### BRIEF DESCRIPTION OF THE DRAWINGS

The above advantages of the present invention will be more clearly understood from the following detailed description taken in conjunction with the accompanying drawings, in which:

FIG. 1 is a graph illustrating the refractive index profile according to various core shape indices;

FIG. 2 is a graph illustrating an optimal core shape index according to a transmission wavelength;

FIG. 3 schematically illustrates a conventional method for fabricating a multimode optical fiber preform;

FIG. 4 is a graph illustrating a bandwidth for each normalized length of a multimode optical fiber obtained by the conventional method for fabricating a multimode optical fiber preform;

FIG. 5 schematically illustrates a method for fabricating a multimode optical fiber preform in accordance with a preferred embodiment of the present invention; and

FIGS. 6 and 7 are graphs illustrating a comparison between a bandwidth curve for each normalized length of the conventional multimode optical fiber and a bandwidth curve for each normalized length of the inventive multimode optical fiber.

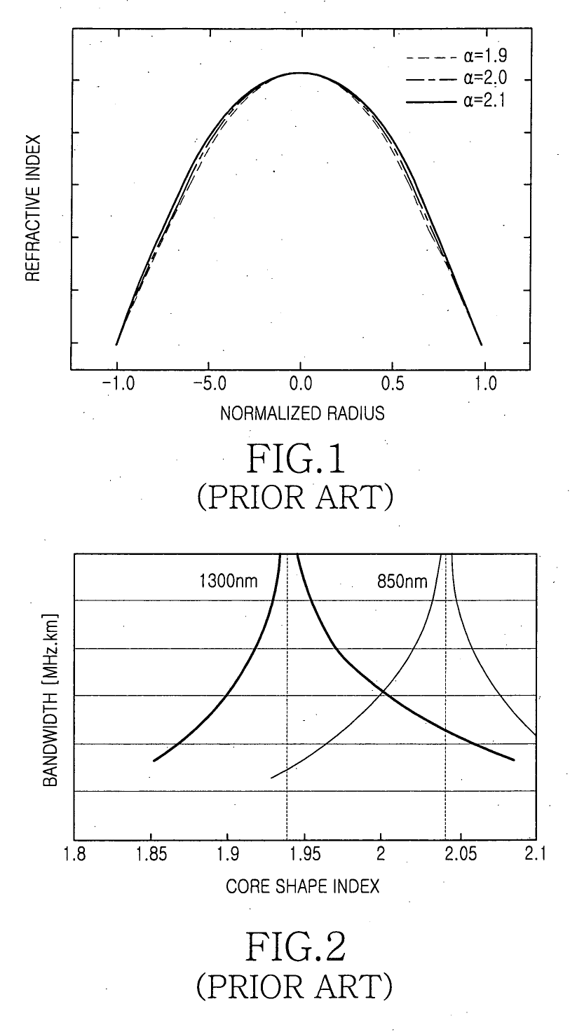

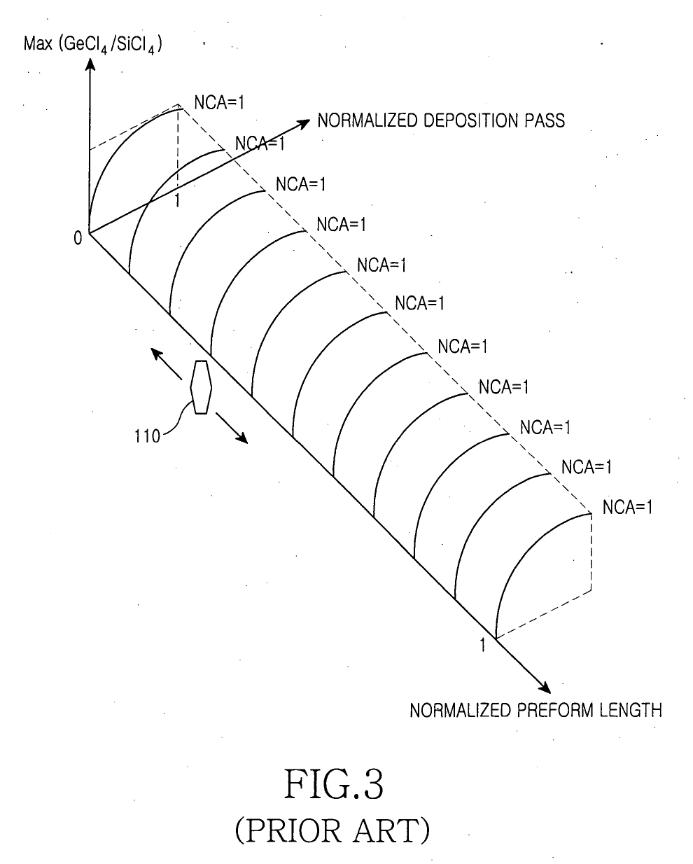

### DETAILED DESCRIPTION

Hereinafter, embodiments of the present invention will be described in detail with reference to the accompanying drawings. For the purposes of clarity and simplicity, a detailed description of known functions and configurations incorporated herein will be omitted as it may make the subject matter of the present invention unclear.

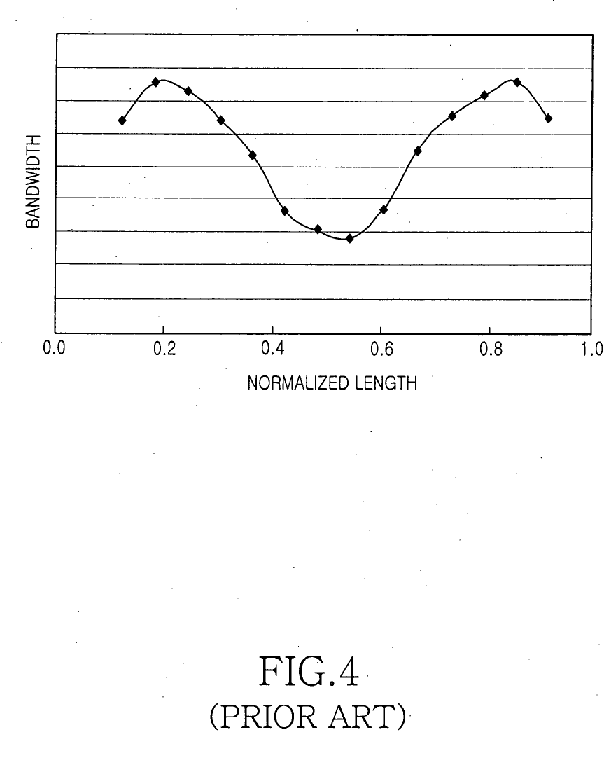

FIG. 4 illustrates graphically a bandwidth for each normalized length of a multimode optical fiber obtained by a conventional method for fabricating a multimode optical fiber preform. In this case, the length has the same meaning as a longitudinal position. From FIG. 4, it can be seen that a bandwidth for a transmission wavelength of 850 nm largely varies in the longitudinal direction.

The present invention utilities the fact that a core shape index distribution in the longitudinal direction of the multimode optical fiber has a shape (i.e., an upward-convex shape) similar to a vertically inverted shape in a bandwidth curve due to the above-described bandwidth variation. Because a refractive index profile of the multimode optical fiber is similar to that of the multimode optical fiber preform, a chemical core shape index distribution is set in each longitudinal deposition pass to compensate for a known error of the conventional chemical core shape index distribution when the multimode optical fiber preform is fabricated.

For example, the present invention sets a chemical core shape index distribution with a downward-convex (or concave) shape in each longitudinal deposition pass to compensate for the error of the conventional chemical core shape index distribution with the upward-convex shape as seen from FIG. 4.

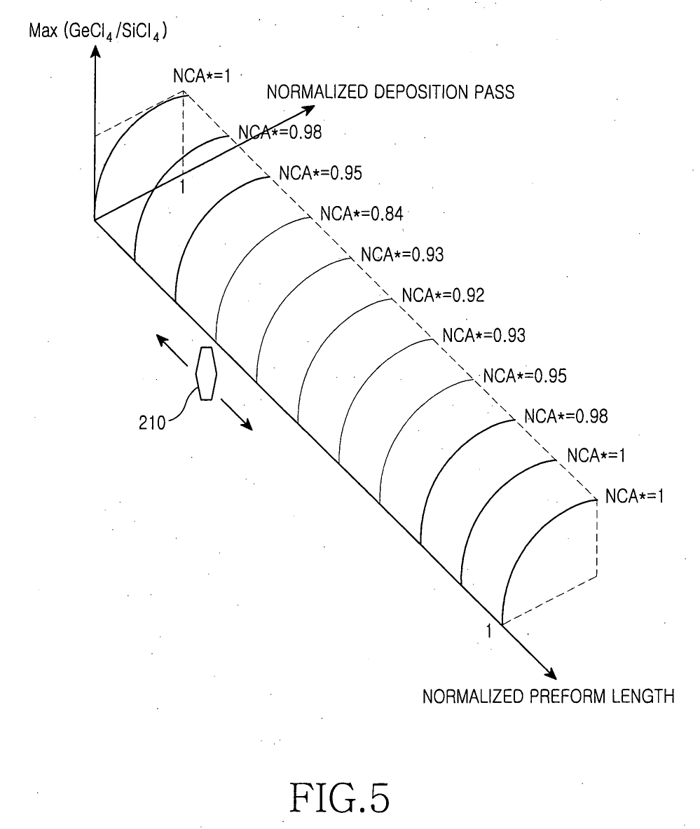

FIG. 5 schematically illustrates a method for fabricating a multimode optical fiber preform in accordance with a preferred embodiment of the present invention.

According to FIG. 5, the fabrication method of the present invention performs a plurality of radial deposition passes while inserting raw materials into a glass tube to implement a hill-type index profile. Each radial deposition pass indicates the step of forming one deposition layer throughout the total length of the glass tube. The total multimode optical fiber preform is configured by a plurality of layers that are stacked on the glass tube and its inner wall and have different refractive indices. After the deposition process, a conventional collapsing process is performed.

As can be seen in FIG. 5, the first axis represents a normalized radial deposition pass. The second axis perpendicular to the first axis represents a maximum ratio of a refractive index control material to a glass-forming material, i.e., Max (GeCl₄/SiCl₄). The third axis corresponding to a movement direction of a thermal source 210 is perpendicular to the first and second axes and represents a normalized preform length. In this case, the length has the same meaning as a longitudinal position. The fabrication method includes processes (a) to (c), below. The normalization indicates, for example, that the first radial deposition pass is set to 0.1 when the total number of radial deposition passes is 10. In this embodiment, the total number of longitudinal deposition passes is set to 10.

In process (a), the chemical core shape index is set for determining a refractive index profile of a preform section (where NCA*=1). The chemical core shape index is the core shape index in the fabrication process. NCA* indicates a chemical core shape index normalized in each position (in the longitudinal direction) or a chemical core shape index normalized in each longitudinal deposition pass. That is, NCA* is a value varying with a longitudinal position. Position information of the thermal source 210 is used for information of the longitudinal position.

When a reference chemical core shape index is set, Max (GeCl₄/SiCl₄) is determined in each radial deposition pass. Max (GeCl₄/SiCl₄) has a large value as the radial deposition pass is performed. This is because the outer circumference of the multimode optical fiber preform has a larger refractive index than the center. An insertion amount of SiCl₄ is set to a constant in a total deposition process. The ratio of GeCl₄ and SiCl₄ inserted in each radial deposition pass directly influences implementation of a preset alpha profile. GeCl₄/SiCl₄ is a function of the normalized radial deposition pass, NCA*, and Max (GeCl₄/SiCl₄). An insertion amount of GeCl₄ is set by a flow equation expressed by Equation (3) similar to Equation (1).
GeCl₄_{_{@p}}=SiCl₄_{_{@p}}×Max(GeCl₄/SiCl₄)[1−(1−NP)^{NCA*}] Equation (3)

In Equation (3), @p denotes each radial process pass, and NP denotes a normalized radial process pass.

Processes (a) to (c) of the fabrication method of the present invention are hereafter described in reference to FIGS. 4 and 5.

In process (b) the chemical core shape index distribution is set according to a position varying in the longitudinal direction of the glass tube such that a known error of a chemical core shape index distribution can be compensated for in the longitudinal direction of the preform for a reference chemical core shape index distribution and such that a uniform chemical core shape index can be obtained in the longitudinal direction. As illustrated in FIG. 5, a core shape index of a core shape index distribution for preset positions gradually decreases from the core shape index of 1 at one end of the preform, 0.92 in the center of the preform, and gradually increases in a direction from the center to the other end of the preform, such that the error of the conventional chemical core shape index distribution with the upward-convex shape as seen from FIG. 4 can be compensated for. That is, the core shape index distribution for the positions has the downward convex shape on the whole.

In process (c) deposition is performed while inserting an amount of raw material corresponding to a preset chemical core shape index in each longitudinal deposition pass of each radial deposition pass. That is, the deposition is performed while an amount of GeCl₄ defined by Equation (3) is inserted.

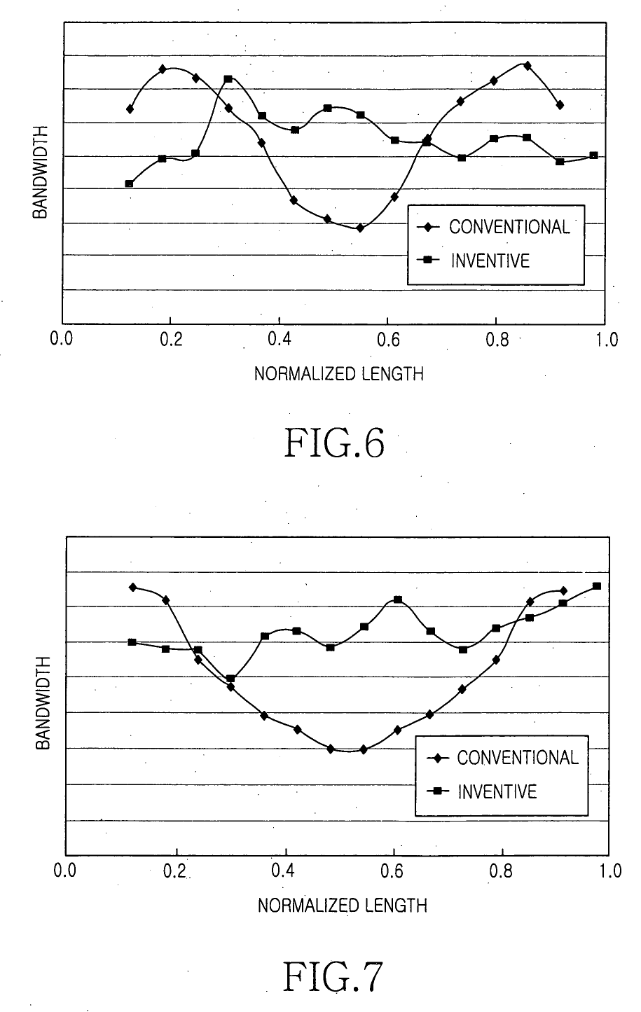

FIGS. 6 and 7 are graphs illustrating a comparison between a bandwidth curve for each normalized length of the conventional multimode optical fiber and a bandwidth curve for each normalized length of the inventive multimode optical fiber. In this case, the length has the same meaning as a longitudinal position. As can be seen in FIG. 6, the inventive multimode optical fiber has a smaller variation width than the conventional multimode optical fiber in a bandwidth for the transmission wavelength of 850 nm in the longitudinal direction. As can be seen in FIG. 7, the inventive multimode optical fiber has a smaller variation width than the conventional multimode optical fiber in a bandwidth for the transmission wavelength of 1,300 nm in the longitudinal direction.

As described above, a method for fabricating a multimode optical fiber preform in accordance with the present invention divides each radial deposition pass into a plurality of longitudinal deposition passes and sets a core shape index distribution of each longitudinal deposition pass varying in the longitudinal direction of the glass tube, thereby obtaining a uniform bandwidth curve in the longitudinal direction.

According to the above-described advantage, the present invention improves longitudinal uniformity of a multimode optical fiber used for a local area network (LAN) or access network at 100 Mbps or for a 1 or 10 gigabit Ethernet. Therefore, optical characteristics and more particularly bandwidth characteristics can be ensured regardless of a length of the multimode optical fiber and transmission quality can be improved.

While the embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method for fabricating a multimode optical fiber preform by performing a plurality of radial deposition passes using a thermal source while inserting raw materials into a glass tube, comprising the steps of:
(a) setting a reference chemical core shape index for determining a refractive index profile of a preform section;
(b) setting a core shape index distribution of each longitudinal deposition pass varying in a longitudinal direction of the glass tube such that an error of a reference chemical core shape index distribution in the longitudinal direction of the preform defined by the reference chemical core shape index is compensated for and such that a uniform chemical core shape index is obtained in the longitudinal direction; and
(c) performing deposition while inserting an amount of raw materials corresponding to a preset chemical core shape index in each longitudinal deposition pass of each radial deposition pass.

2. The method of claim 1, wherein Max (B/A) is determined which represents a maximum ratio of a refractive index control material B to a glass-forming material A in each radial deposition pass when the reference chemical core shape index is set, and wherein an amount of the refractive index control material B inserted in each longitudinal deposition pass of the step (c) is given by:
B_{@p}=A_{@p}×Max(B/A)[1−(1−NP)^{NCA*}], where @p denotes each radial process pass, NP denotes a normalized radial process pass, and NCA* denotes a normalized chemical core shape index in each longitudinal deposition pass.

3. The method of claim 2, wherein the glass-forming material is SiCl₄, and wherein the refractive index control material is GeCl₄.

4. The method of claim 2, wherein NCA* is a value varying with a longitudinal position, and wherein position information of the thermal source is used for information of the longitudinal position.

5. The method of claim 1, wherein the raw materials are GeCl₄, SiCl₄, reaction oxygen, helium gas, and a deposition temperature.

6. The method of claim 1, wherein the plurality of radial deposition passes has a hill-type shape index profile.

7. The method of claim 1, wherein the first radial deposition pass is set to at least 0.1.

8. The method of claim 1, wherein the total number of radial deposition passes is at least 10.

9. The method of claim 1, wherein the core shape index distribution has a downward concave shape.

10. The method of claim 1, wherein the core shape index distribution has a downward convex shape.
